(19) United States
(12) Patent Application Publication
(10) Pub. No.: US 2009/0128895 A1
(43) Pub. Date: May 21, 2009

(54) FILTER FOR DISPLAY DEVICE

(75) Inventors: Ji-Yoon Seo, ChungCheongNam-Do (KR); Dong-Keun Sin, ChungCheongNam-Do (KR); Sang-Yoon Oh, ChungCheongNam-Do (KR); Dae Chul Park, ChungCheongNam-Do (KR); Ji-Young Kim, ChungCheongNam-Do (KR)

Correspondence Address: MCDERMOTT WILL & EMERY LLP, 600 13TH STREET, N.W., WASHINGTON, DC, 20005-3096, US

(73) Assignee: SAMSUNG CORNING PRECISION GLASS CO., LTD.

(21) Appl. No.: 12/274,700

(22) Filed: Nov. 20, 2008

(30) Foreign Application Priority Data
Nov. 20, 2007 (KR) 10-2007-0118501

(51) Int. Cl. F21V 9/04

(52) U.S. Cl. 359/360

(57) ABSTRACT

A filter 100 for a display device includes a transparent substrate 110; a near infrared ray blocking layer 120; and electromagnetic shielding layer 130; an external light blocking layer 140; and a color compensation layer 150. The near infrared ray blocking layer 120 is formed on the transparent substrate 110 and includes a metal thin film and a metal oxide thin film which are alternately layered, each of the metal thin film and the metal oxide thin film being layered one or more times. The electromagnetic shielding layer 130 is formed on the near infrared ray blocking layer 120 and includes a metal mesh pattern. The external light blocking layer 140 includes an external light blocking pattern 144, the external light blocking pattern including a plurality of external light blocking parts with a wedge shape which are filled with a light absorbing material and a conductive material. The color compensation layer 150 is formed on the external light blocking layer 140 and includes a polymer resin and at least two kinds of colorants selectively absorbing lights. The filter 100 has a transmittance of 5% or less at an 850 nm wavelength. The filter 100 has excellent performance in blocking near infrared rays and electromagnetic waves and high transmittance to visible light.

### CROSS-REFERENCE TO RELATED APPLICATION

This application claims the benefit of Korean Patent Application No. 10-2007-0118501 filed on Nov. 20, 2007 with the Korean Intellectual Property Office, the disclosure of which is incorporated herein by reference.

### BACKGROUND OF THE INVENTION

1. Field of the Invention

The present invention relates to a filter for a display device which has excellent performance in blocking near infrared rays and electromagnetic waves and high transmittance to visible light.

2. Description of the Related Art

Display devices include televisions, monitors of personal computers, portable display devices, and so on. Display devices are recently getting larger sized and thinner.

Accordingly, flat panel display (FPD) devices such as plasma display panel (PDP) devices, liquid crystal display (LCD) devices, field emission display (FED) devices, and organic light emitting display (OLED) devices take the place of cathode ray tube (CRT) devices, which was representative of display devices.

Hereinafter, PDP devices and a filter therefor will be exemplified but the present invention is not limited thereto. For example, a filter according to the present invention can be used for large sized display devices such as OLED devices, LCD devices and FED devices; small sized display devices such as Personal Digital Assistance (PDA) devices, display devices for small sized game machines, display devices for small mobile phones; and flexible display devices.

Especially, PDP devices are in the limelight since they have excellent display characteristics such as high luminance, a high contrast ratio, low after-image, and a wide viewing angle.

PDP devices cause gas discharge between electrodes by applying a direct or alternating voltage to the electrodes, then a fluorescent material is irradiated with ultraviolet rays caused by the gas discharge to be activated, and thereby light is generated. PDP devices display images by using the generated light.

However, a conventional PDP device has drawbacks in that a large amount of electromagnetic waves and near infrared rays is emitted due to its intrinsic characteristics. The electromagnetic waves and near infrared rays emitted from the PDP device may have a harmful effect to the human body, and cause malfunction of precision appliances such as a cellular phone and a remote controller. Further, the PDP device has a high surface reflection and has lower color purity than CRT devices due to orange color light emitted from gas such as He or Xe.

Therefore, the PDP device uses a PDP filter in order to block the electromagnetic waves and near infrared rays, reduce the light reflection, and improve the color purity. The PDP filter is installed in front of a panel assembly. The PDP filter is generally fabricated by the adhesion or bonding between a plurality of functional layers such as an electromagnetic shielding layer, a near infrared ray blocking layer, a neon peak absorbing layer, etc.

However, the conventional near infrared ray blocking layer is made by mixing a colorant which absorbs near infrared rays, in a polymer resin. In order to improve the efficiency of absorbing near infrared rays, a large amount of the colorant is required, which increases the cost and decreases the light transmittance of the filter.

### SUMMARY OF THE INVENTION

The present invention is intended to solve the foregoing problems with the conventional art. An object of the present invention is to provide a filter for a display device which efficiently blocks near infrared rays and electromagnetic waves without using a colorant to absorb near infrared rays and has high transmittance to visible light.

Another object of the present invention is to provide a filter for a display device which has a good reproduction range by optimizing a mixing ratio of a colorant in a color compensation layer using an existing process.

Still another object of the present invention is to provide a filter for a display device which has excellent transmittance and color compensation ability and at the same time, effectively blocks near infrared rays and electromagnetic waves.

In order to achieve the above-mentioned objects, the present invention provides a filter for a display device which includes a transparent substrate; a near infrared ray blocking layer in which a metal thin film and a metal oxide thin film are layered one or more times; an electromagnetic shielding layer including a conductive mesh pattern; an external light blocking layer including an external light blocking pattern which has a plurality of external light blocking parts with a wedge shape filled with a light absorbing material and a conductive material; and a color compensation layer being formed on the external light blocking layer and including a polymer resin and at least two kinds of colorants selectively absorbing light, wherein the filter has a transmittance of 5% or less at a 850 nm wavelength.

The transparent substrate can be made of glass or a transparent polymer resin. An example of the transparent polymer resin is polyetylene terephthalate (PET), acryl, polycarbonate (PC), urethane acrylate, polyester, epoxy acrylate, brominate acrylate, polyvinyl chloride (PVC), or the like. The electromagnetic shielding layer can be a film with a metal mesh pattern.

In order to increase the efficiency of blocking electromagnetic waves, the external light blocking layer can include the conductive material as well as the light absorbing material in its external light blocking parts. A black material such as carbon black can be used as the light absorbing material. An example of the conductive material is metal such as silver, cooper, or the like. Especially, silver paste containing nano-sized silver powder or blackened silver paste can be used as the conductive material.

The near infrared ray blocking layer can have a total thickness of 500 nm or less.

Preferably, each of the metal thin film and the metal oxide thin film can be layered once or twice. The metal thin film can have a thickness of 10˜50 nm and the metal oxide thin film can have a thickness of 3˜60 nm.

The color compensation layer can include 0.01˜1 parts by weight of a first colorant which absorbs light with wavelengths of 430˜500 nm and 0.01˜1 parts by weight of a second colorant which absorbs light with wavelengths of 560˜620 nm based on 100 parts by weight of the polymer resin. Examples of the first colorant and the second colorant are at least one of cyanine type colorant, an anthraquinone type colorant, a naphthoquinone type colorant, a phthalocyanine type colorant, a naphthalocyanine type colorant, a diimmonium type colorant, a nickel dithiol type colorant, an azo type colorant, a stryl type colorant, a methine type colorant, a porphyrin type colorant and an azaporphyrin type colorant. Each colorant selectively absorbs light with wavelengths in the range of 430˜500 nm or 560˜620 nm and absorbs light with a specific wavelength the most.

The near infrared ray blocking layer can have a transmittance of 85% or more to visible light. The filter can have a transmittance of 45% or more to visible light and a sheet resistance of 0.05Ω/□ or less.

The filter can be used for RGB type display devices such as PDP devices, OLED devices, LCD devices, FED devices, or the like.

The present invention can provide a filter for a display device which can efficiently perform multiple functions since it has excellent performance in blocking near infrared rays and electromagnetic waves and has a good transmittance and a broad color reproduction range.

In addition, the filter can be fabricated by using an existing process, which makes the fabrication process efficient and enables the mass production. Especially, the filter does not use a colorant for blocking near infrared rays, which enables the fabrication cost to decrease and the filter to have an excellent transmittance.

### BRIEF DESCRIPTION OF THE DRAWINGS

The above and other objects, features and other advantages of the present invention will be more clearly understood from the following detailed description taken in conjunction with the accompanying drawings, in which:

FIG. 1 is a cross-sectional view illustrating a filter for a display device according to an embodiment of the present invention,

FIG. 2 is a spectral transmittance curve showing a relationship between transmittances and wavelengths in a near infrared ray blocking layer according to the present invention and a conventional near infrared ray blocking layer, and

FIG. 3 is a spectral transmittance curve showing a relationship between transmittances and wavelengths in a filter according to the present invention and a conventional filter.

### DETAILED DESCRIPTION OF THE EXEMPLARY EMBODIMENT

The present invention will now be described more fully hereinafter with reference to the accompanying drawings, in which exemplary embodiments thereof are shown.

Although not shown, a PDP device according to the present invention includes a case; a cover covering the case; a driving circuit board housed in the case; a panel assembly including light emitting cells in which gas discharge occurs and a fluorescent layer; and a PDP filter. The light emitting cell contains a discharge gas. For example, a Ne—Xe based gas, a He—Xe based gas or the like can be used as the discharge gas. The panel assembly emits light in a similar way to a fluorescent lamp. That is, the gas discharge occurs in the light emitting cells and the discharge gas emits ultraviolet rays, and then the emitted ultraviolet rays activate the fluorescent layer in the panel assembly to produce visible light.

The PDP filter is arranged in front of the panel assembly. The PDP filter can be installed apart from the display panel or in contact with the display panel. The PDP filter can adhere to or bond with a front substrate of the panel assembly by an adhesive or a bonding agent, which prevents dust from sticking to the PDP filter and compensates for the strength of the filter.

The filter can include an electromagnetic shielding layer made of a material with high conductivity. The electromagnetic shielding layer is grounded through the cover to the case. Accordingly, before electromagnetic waves caused by the panel assembly reaches a viewer, it is discharged though the electromagnetic shielding layer and the cover to the case.

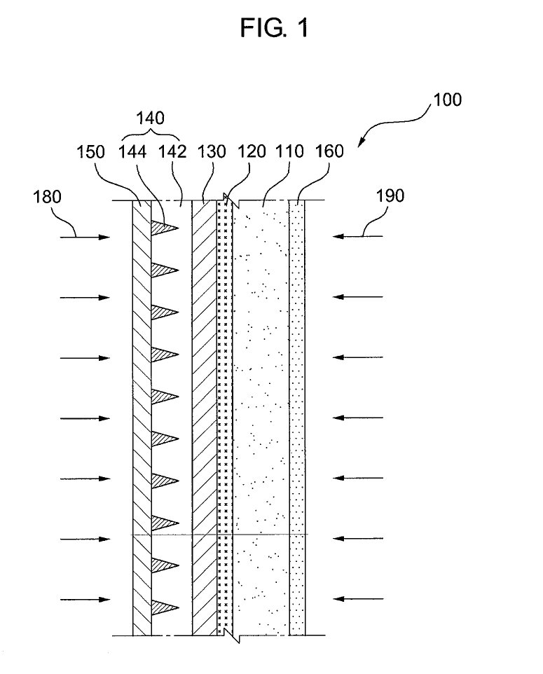

FIG. 1 is a cross sectional view illustrating a PDP filter 100 according to an embodiment of the present invention.

Referring to FIG. 1, the filter 100 can include various functional optical members such as a near infrared ray blocking layer, an electromagnetic shielding layer 130, an external light blocking layer 140, a color compensation layer 150, an anti-reflection layer 160, and the like.

The near infrared ray blocking layer, the electromagnetic shielding layer 130, the external light blocking layer 140 and the color compensation layer 150 are placed on one side of the transparent substrate 110 facing a panel assembly, while the anti-reflection layer 160 is placed on the other side of the transparent substrate 110 onto which external light 190 is incident.

The filter can include a hybrid optical member which can perform multiple functions at the same time.

The transparent substrate 110 can be made of an inorganic compound such as glass, quartz, or the like or a transparent organic polymer. An example of the organic polymer is acryl, polycarbonate or the like, but the present invention is not limited thereto. The transparent substrate 110 preferably has high transmittance and thermal resistance. A formed polymer substrate obtained by a forming process or a substrate in which formed polymer substrates are multi-layered can be used as the transparent substrate 110. The transparent substrate 110 preferably has a transmittance of 80% or more to visible light. As far as thermal resistance is concerned, the transparent substrate 110 preferably has a glass transition temperature of 50° C. or more. The formed polymer substrate has to be transparent to visible light. Polyethylene terephthalate is preferable as the material of the transparent substrate 110, considering cost, thermal resistance and transmittance. However, the present invention is not limited thereto. In some embodiments, the transparent substrate 110 can be excluded from the filter.

The anti-reflection layer 160 prevents the external light 190 incident from the outside from being reflected back toward the outside to improve the contrast ratio of the display device. It is preferable that the anti-reflection layer 160 is placed on the other side of the transparent substrate 110 which faces in the direction of a viewer.

The electromagnetic shielding layer 130 blocks electromagnetic waves caused by the panel assembly. In order to block the electromagnetic waves, it is required to cover a surface of the panel assembly with a high conductive material. A film with a conductive mesh pattern can be used as the electromagnetic shielding layer 130. A grounded metal mesh, a metal coated synthetic resin mesh or a metal coated metal fiber mesh can be used for the film. Cooper, chrome, nickel, silver, tungsten, aluminum, or the like which has good electric conductivity and good workability can be used as the metal for the film.

Although not shown, the PDP filter can include a diffusion layer. The diffusion layer prevents a moiré phenomenon and a newton ring phenomenon which occur due to the interference between incident light and reflected light when regular patterns of the external light blocking layer 140 and the electromagnetic shielding layer 130 are reflected by the front substrate of the panel assembly. The diffusion layer can be placed in various positions but it is preferable that the diffusion layer is placed on one surface of the PDP filter near to the panel assembly. The diffusion layer can be provided as a separate layer or can be incorporated into another functional layer.

The external light blocking layer 140 includes a transparent base 142 and an external light blocking pattern 144 formed at the base 142. The external light blocking pattern 144 includes a plurality of external light blocking parts. The external light blocking pattern 144 forms stripes with a wedge shape, that is, a plurality of three dimensional triangular prisms, but the present invention is not limited thereto.

The external light blocking layer 140 is placed on the opposite side of the transparent substrate 110 from the anti-reflection layer 160. The external light blocking layer 140 is placed on the electromagnetic shielding layer 130. These arrangements enable the external blocking layer to efficiently absorb the external light 190 and transmit the light 180 emitted from the panel assembly.

In this embodiment, a bottom surface of the external light blocking part being even with one surface of the base 142 faces the panel assembly, but the present invention is not limited thereto. That is, the bottom surface can face a viewer or the external light blocking parts can be formed on both sides of the base 142.

The base 142 functions as a support and has a plate shape. The base 142 can be made of a transparent material transmitting visible light such as glass, polyetylene terephthalate (PET), acryl, polycarbonate (PC), urethane acrylate, polyester, epoxy acrylate, brominate acrylate, polyvinyl chloride (PVC), or the like.

The external light blocking layer 140 absorbs the external light 190 to prevent the external light 190 from entering toward the panel assembly and at the same time, totally reflects the light 180 emitted from the panel assembly toward a viewer. This enables high transmittance and contrast ratio to be obtained. In addition, the external light blocking layer 140 can include a conductive material as well as a light absorbing material in the external light blocking pattern 144, whereby it can perform the function of blocking electromagnetic waves as well.

The external light blocking part can have a cross section with a wedge shape, a trapezoidal shape, a semi-circular shape, a U shape, or the like. The light absorbing material can be a black material such as carbon black. The conductive material can be silver paste.

The external light blocking part can be filled with a polymer resin in which a binder, etc. are mixed, as well as the light absorbing material and the conductive material. The polymer resin preferably has a lower refractive index than the base 142. This enables the boundary surface between the base 142 and the external light blocking part to totally reflect the light 180 entering from the panel assembly to improve the contrast ratio.

Hereinafter, the near infrared ray blocking layer and the color compensation layer 150 will be described in more detail.

The near infrared ray blocking layer is disposed on one surface of the transparent substrate 110. The near infrared ray blocking layer is made in a multi-layered form by coating a metal thin film and a metal oxide thin film on the transparent substrate 110. The near infrared ray blocking layer blocks near infrared rays which are caused by the panel assembly and cause a malfunction of electronic appliances such as a wireless phone or a remote controller.

The near infrared ray blocking layer uses the thin film of transparent metal oxide represented by indium tin oxide (ITO) to block near infrared rays. The metal thin film includes a metal such as gold, silver, cooper, white gold, palladium or the like. The metal oxide thin film includes a metal oxide such as indium tin oxide, titanium oxide, indium oxide, SnO₂, Sb₂O₃, zinc oxide, aluminum doped zinc oxide, or the like.

The thickness of the metal thin film can be 10˜50 nm and the thickness of the metal oxide thin film can be 3˜60 nm. The total thickness of the near infrared ray blocking layer in which each of the metal thin film and the metal oxide thin film is layered once can be 50˜200 nm. The total thickness of the near infrared ray blocking layer in which each of the metal thin film and the metal oxide thin film twice can be 100˜400 nm. Preferably, the total thickness of the near infrared ray blocking layer has to be 500 nm or less, irrespective of the number of the layered thin films. Although the near infrared ray blocking layer in which each of the metal thin film and the metal oxide thin film is layered one to four times can have a good ability to block near infrared rays, it is preferable that the number of the layered thin films is one or two as mentioned above, considering light transmittance.

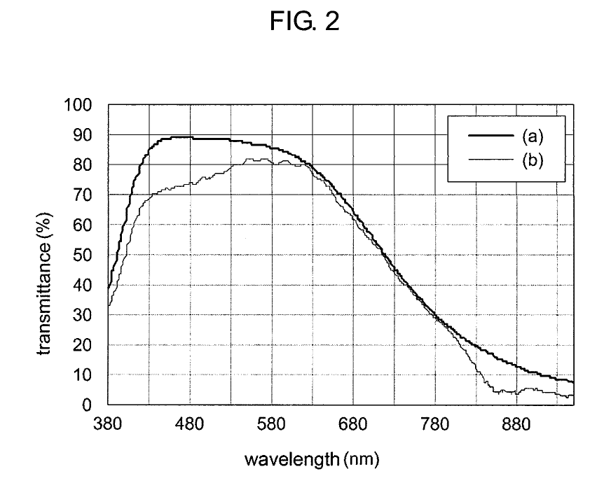

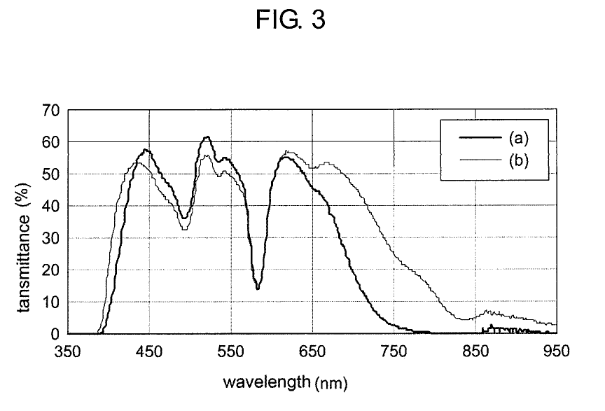

The near infrared ray blocking layer preferably has a transmittance of 85% or more to visible light. The PDP filter including the near infrared ray blocking layer preferably has a transmittance of 45% or more to visible light. In addition, the near infrared ray blocking layer preferably has a transmittance of 5% or less to light with a wavelength of 850 nm. Hereinafter, referring to FIGS. 2 and 3, the light transmittance of the near infrared ray blocking layer will be described.

Referring to FIG. 2, a near infrared ray blocking layer (a) according to the present invention has a better transmittance to visible rays with wavelengths of 380˜680 nm than a conventional near infrared ray blocking layer (b) using a colorant.

Referring to FIG. 3, a filter (a) according to the present invention has a lower transmittance to the light with an 850 nm wavelength than a conventional filter (b) including a conventional near infrared ray blocking layer. This means that the filter (a) can block near infrared rays more effectively than the filter (b).

As mentioned above, the present invention does not use the near infrared ray blocking layer containing the colorant but the near infrared ray blocking layer in which the metal thin film and the metal oxide thin film are alternately layered on the transparent substrate, thereby improving the transmittance of visible light.

In addition, since the near infrared ray blocking layer can perform the function of blocking electromagnetic waves, it can lower the sheet resistance of the filter to 0.05Ω/□ or less. The sheet resistance of 0.050/Ω□ or less is difficult for the filter using the conventional near infrared ray blocking layer containing the colorant to obtain. Furthermore, since the filter according to the present invention can include a conductive material in the external light blocking parts, the filter can more improve electromagnetic shielding efficiency.

The PDP filter includes the color compensation layer which contains a polymer resin and at least two kinds of colorants selectively absorbing lights with a specific wavelength. The color compensation layer is formed on one surface of the external light blocking layer facing the panel assembly. The color compensation layer reduces or adjusts the amounts of Red, Green or Blue light to change or correct color balance, thereby improving the color reproduction range and image quality.

The color compensation layer can include various colorants. A dye or a pigment can be used as the colorant. Examples of the colorant are an organic colorant having a function of blocking neon light such as cyanine type colorant, an anthraquinone type colorant, an azo type colorant, a stryl type colorant, a phthalocyanine type colorant, a methine type colorant or the like, but the present invention is not limited thereto.

The color compensation layer includes 0.01˜1 parts by weight of a first colorant which absorbs light with the wavelength of 430 nm˜500 nm and 0.01˜1 parts by weight of a second colorant which absorbs light with the wavelength of 560˜620 nm based on 100 parts by weight of the polymer resin. The first colorant performs a cyan cut function of absorbing the light in the range of Blue and Green. The second colorant performs a neon light cut function. The first colorant improves the Blue color purity and Green color purity and thus the color reproduction range. Especially, it is possible to improve the color reproduction range by adjusting the mixing ratio between the first colorant and the second colorant to make the amounts of Red light, Green light and Blue light traveling through the filter equal.

Table 1 below shows the results of tests in which a PDP module (a) without a PDP filter, a PDP module (b) with a filter including a color compensation layer containing 0.1 part by weight of the second colorant only, and a PDP module (c) with a filter including 0.7 parts and 0.1 part by weight of the first colorant and the second colorant, respectively were tested. HD (High Definition) PDP modules made by Samsung SDI were used as the PDP module for the test. Comparing the results in (b) and (c) to each other, a color reproduction range in (b) is 89.1%, while a color reproduction range in (c) according to the present invention increases to 91.5%.

TABLE 1

| | | | (a) | (b) | (c) |
|---|---|---|---|---|---|
| Amount of light emitted | | | 2.85E−01 | 1.30E−01 | 1.43E−01 |
| Color | x | | 0.2775 | 0.2724 | 0.2664 |
| coordinate | y | | 0.2954 | 0.2867 | 0.2941 |
| Color purity | | | 9,942 | 11,104 | 11,291 |
| Color | R | Amount of | 1.44E−01 | 6.58E−02 | 6.37E−02 |
| | | light emitted | | | |
| coordinate | | x | 0.6469 | 0.6614 | 0.6579 |
| of RGB | | y | 0.3429 | 0.3282 | 0.3310 |
| | G | Amount of | 4.35E−01 | 1.95E−01 | 2.26E−01 |
| | | light emitted | | | |
| | | x | 0.2787 | 0.2608 | 0.2607 |
| | | y | 0.6612 | 0.6663 | 0.6829 |
| | B | Amount of | 6.54E−02 | 3.42E−02 | 3.20E−02 |
| | | light emitted | | | |
| | | x | 0.1493 | 0.1465 | 0.1502 |
| | | y | 0.0547 | 0.0589 | 0.0517 |

| | | | |
|---|---|---|---|
| Color reproduction range (xy) | 0.1322 | 0.1410 | 0.1448 |
| Compared to NTSC | 83.6% | 89.1% | 91.5% |

Table 2 below shows light transmittances and color coordinates of a PDP filter (d) including a near infrared ray blocking layer containing a colorant and a PDP filter (e) including a near infrared ray blocking layer in which a plurality of films are layered. The light transmittances are the transmittance of visible light which were measured under CIE Standard Illuminant D65. From the results in Table 2, it can be seen that the light transmittance of the filter including the near infrared ray blocking layer according to the present invention is more than 45%.

TABLE 2

| | Light transmittance | Color coordinate (x) | Color coordinate (y) |
|---|---|---|---|
| (d) | 43.2% | 0.300 | 0.318 |
| (e) | 46.3% | 0.298 | 0.321 |

As mentioned above, the filter according to the present invention can block neon light, cyan light, near infrared rays and electromagnetic waves and at the same time, can have high visible light transmittance.

What is claimed is:

1. A filter for a display device comprising:
a transparent substrate;
a near infrared ray blocking layer comprising a metal thin film and a metal oxide thin film which are alternately layered, each of the metal thin film and the metal oxide thin film being layered one or more times; and
an electromagnetic shielding layer comprising a conductive mesh pattern.

2. The filter for the display device of claim 1 further comprising an external light blocking layer,
wherein the external light blocking layer comprises an external light blocking pattern and the external light blocking pattern comprises a plurality of external light blocking parts with a wedge shape which are filled with a light absorbing material and a conductive material.

3. The filter for the display device of claim 1 further comprising a color compensation layer,
wherein the color compensation layer comprises a polymer resin and at least two kinds of colorants which selectively absorb lights.

4. The filter for the display device of claim 3,
wherein the color compensation layer comprises a first colorant absorbing light with wavelengths of 430 nm˜500 nm and a second colorant absorbing light with wavelengths of 560 nm˜620 nm.

5. The filter for the display device of claim 4,
wherein the color compensation layer comprises 0.01˜1 parts by weight of the first colorant and 0.01˜1 parts by weight of the second colorant based on 100 parts by weight of the polymer resin.

6. The filter for the display device of claim 1,
wherein the filter has a transmittance of 5% or less at an 850 nm wavelength.

7. The filter for the display device of claim 1,
wherein the near infrared ray blocking layer has a total thickness of 500 nm or less.

8. The filter for the display device of claim 1,
wherein the metal thin film has a thickness of 10˜50 nm, and the metal oxide thin film has a thickness of 3˜60 nm.

9. The filter for the display device of claim 8,
wherein each of the metal thin film and the metal oxide thin film are layered once or twice.

10. The filter for the display device of claim 1,
wherein the near infrared ray blocking layer has a transmittance of 85% or more to visible light, and the filter has a transmittance of 45% or more to visible light.

11. The filter for the display device of claim 1,
wherein the filter has a sheet resistance of 0.05Ω/□ or less.
